(19) United States
(12) Patent Application Publication
(10) Pub. No.: US 2004/0017682 A1
(43) Pub. Date: Jan. 29, 2004

(54) LED compact case

(76) Inventor: Robert Baskies, Winthrop, MA (US)

Correspondence Address: Robert Baskies, 211 Lincoln Street, Winthrop, MA, 02152, US

(21) Appl. No.: 10/205,126

(22) Filed: Jul. 25, 2002

(51) Int. Cl. F21V 33/00

(52) U.S. Cl. 362/136; 362/156

(57) ABSTRACT

W makeup compact case is provided utilizing Light Emitting Diodes (LED) as an illumination source The LED's are inserted into the plastic housing of the case lid, next to the mirror in order to simulate actual sunlight. Traditional illuminating devices do not accurately reflect the hues of sunlight and as such do not accurately replicate how the makeup will look once the individual has entered a sunlight environment. The LED's are powered by Lithium low-voltage batteries, or other such replaceable power source, and will be activated by a push-button switch, or other such connect/disconnect device, inserted into the lower case housing

### CROSS REFERENCE TO RELATED APPLICATIONS

None

### STATEMENT REGARDING FEDERALLY SPONSORED RESEARCH OR DEVELOPMENT

Not Applicable.

### REFERENCE TO MICROFICHE APPENDIX

Not Applicable

### BACKGROUND OF THE INVENTION

Dr. Baskies invented the LED Compact case as a result of research and experimentation into the use of LED's in the field of dentistry. Dr. Baskies discovered that LED's produce a near-perfect replication of sunlight and as such as perfect for use in devices that require or are dependent upon the hues produced by sunlight, as opposed to traditional artificial illumination.

### BRIEF SUMMARY OF THE INVENTION

The LED Compact Case is a standard plastic cosmetic case of any form or type, with attached mirror, used for the application of makeup. The LED, or Light Emitting Diode, portion of the case works in conjunction with the mirror to allow the user to apply the makeup in lighting conditions that optimize application in an environment that, because of the LED output of light, simulates standard daylight.

### BRIEF DESCRIPTION OF THE SEVERAL VIEWS OF THE DRAWING

There are three (3) drawings being provided with this Application:

FIG. 1: Top view of the compact case showing the Lid, Storage Area, Mirror, Switch and LED

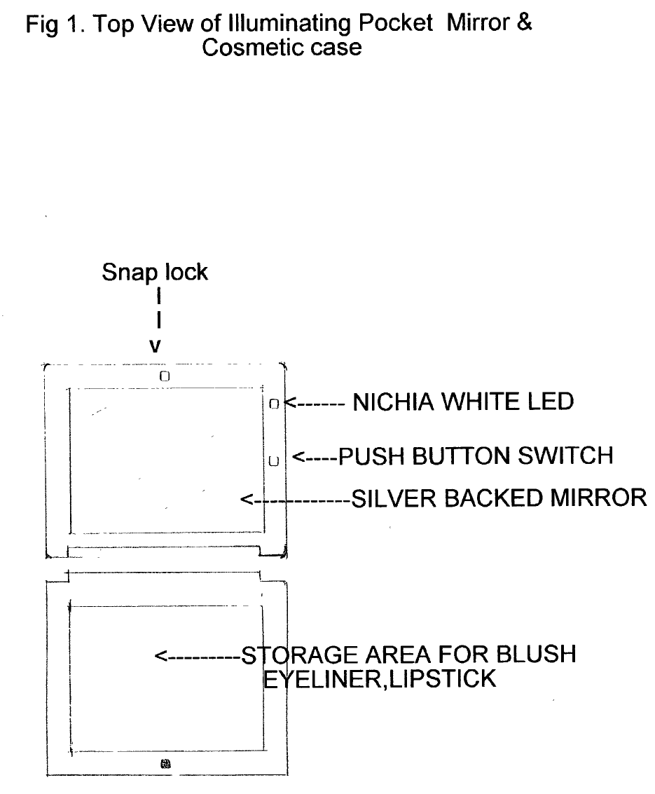

FIG. 2: Top view of the compact case, with the mirror removed, showing the location of the four (4) lithium batteries.

FIG. 3: Cross-section of the right side of the compact case, showing the manner in which the lithium batteries and switch will be installed in the unit, including the electrical connection between the batteries and the switch.

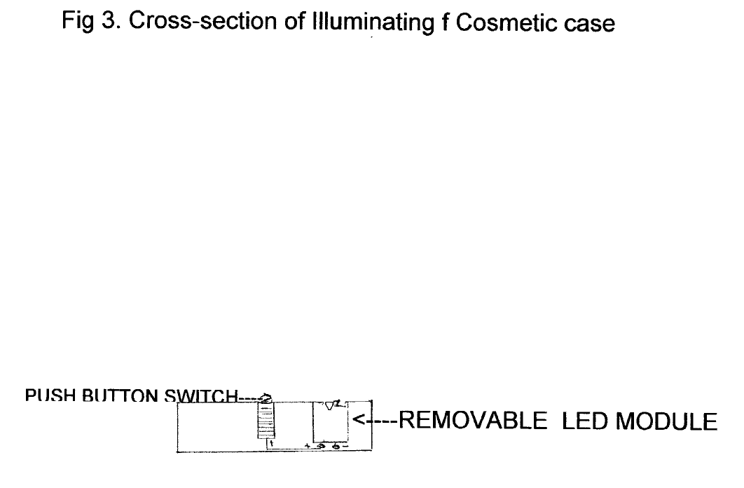

### DETAILED DESCRIPTION OF THE INVENTION

The LED Compact Case is a standard cosmetic case of any form or type, with attached mirror, used for the application of makeup. The cases are made from durable plastic, typically using injection-molding techniques. The LED, or Light Emitting Diode, portion of the case works in conjunction with the mirror to allow the user to apply the makeup in lighting conditions that optimize application in an environment that, because of the LED output of light, simulates standard daylight. The LED's are attached to the housing via a bonding agent, thermal fusion or other techniques well known in the plastics industry.

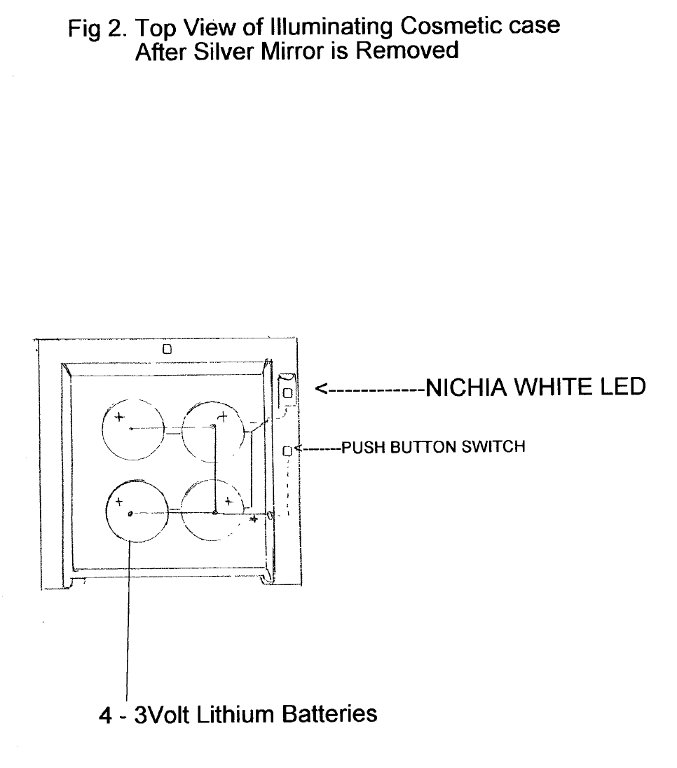

The case contains 4 3-volt lithium batteries as a power source, which are housed in a compartment within the lid portion of the case under the mirror (See FIG. 2). Also included are two (2) to ten (10) or more Nichia or equivalent white LED's and a standard push-button switch that will cause the LED's to be activated once the case is opened, and deactivated when the case is closed.

The LED's are incorporated into the plastic lid housing surrounding the mirror and are connected to the batteries via small gauge standard insulated wire, bypassed through the push-button switch that will complete the connection when the lid is open and break the connection when the lid is closed.

What Dr. Baskies claims as his invention is:

1. The use of led lighting in a makeup compact case
Four lithium batteries as a power source
A push-button switch contained in the housing that is activated when the lid is opened and de-activated when the lid is closed
The LED work in conjunction with a mirror to produce a true lighting environment that closely simulates sunlight.
